(19) United States
(12) Patent Application Publication
(10) Pub. No.: US 2009/0125559 A1
(43) Pub. Date: May 14, 2009

(54) METHOD, APPARATUS AND SYSTEM FOR CREATING INTEREST INFORMATION

(75) Inventor: Tatsuo YOSHINO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/263,975

(22) Filed: Nov. 3, 2008

(30) Foreign Application Priority Data
Nov. 2, 2007 (JP) 2007-286261

(51) Int. Cl. G06F 17/00; H04N 7/26

(52) U.S. Cl. 707/104.1; 386/124; 707/E17.001; 386/E05.001

(57) ABSTRACT

A frame number of a frame in interest (playback position identification information) in which a correlated region can be traced based on a certain initial reference region (for example, an interesting region on which user-designated addresses concentrate), position coordinates of an interesting region (coordinates identification information), and position coordinates of the correlated region (coordinates identification information) are associated with designation information as interest information and stored in the interest information DB. An analyst of user interest (a distributor of related information) can know which element in a content a user is especially interested in by collating the actual moving image content with the interest information and can register appropriate related information based on the interest.

### BACKGROUND OF THE INVENTION

1. Field of the Invention

The present invention relates to a technique to provide useful information in distribution of information corresponding to various contents.

2. Description of the Related Art

A technique is required to interactively get information from a content distributed by broadcasting or on-demand. Especially for a moving image of which content details instantly and continuously transit, if a viewer wants to get information in a moment, there is no time to take a note. Accordingly, the viewer must primitively record the content and view the content again later.

In digital terrestrial broadcasting, a data broadcast is sent in parallel to a video picture broadcast. However, the broadcasting is not fully compatible with the Internet, so that it is difficult to link information from data in the data broadcast. The BML (Broadcast Markup Language: XML-based page description language for a data broadcast) format is made suitable to the HTML format such that information linking can be possible to a certain extent, but it is difficult to send data in a form synchronized with a moving image in a complex language. Particularly, it is difficult to link information according to a transiting moving image scene.

In view of the above, to get necessary information by clicking an area in an interesting scene while viewing a moving image, a technique of clickable video map has been developed (Japanese Patent Application Laid-Open No. 2004-274350). It is a mechanism for supplying data to set a hot spot region associated with information in a display screen for a moving image content together, and getting information (URL) associated with the region when a viewer clicks the region. For the technique, related information is embedded in a multimedia definition language such as the SMIL language (Synchronized Multimedia Integration Language). With the method, if the clicked region has related information, the related information can be got.

In an image distribution system according to Japanese Patent Application Laid-Open No. 2004-274350, an attached information selecting function section supplies a designated clickable video map to a requesting user terminal apparatus by attaching the map to an image content from an image distribution server in response to an image distribution request by the user terminal apparatus, and displays the image. Further, the user terminal apparatus selects a clickable video map ID contained in the clickable video map as the information distribution request and supplies the ID to a Web server. The attached information selecting function section selects an HTML file from HTML files by comparing the supplied ID to IDs contained in an attached information table, sends/displays the HTML file to/on the user terminal apparatus.

According to Japanese Patent Application Laid-Open No. 2005-286882, a system comprises a terminal of a video picture viewer who views a moving image as a broadband content, and a CM moving image distribution server in a network of a video picture provider that provides a CM moving image video picture content. The CM moving image distribution server distributes a CM moving image to the terminal in response to a viewing request issued from the terminal. The terminal comprises a device which designates a product information request for a viewer-desired product in the CM moving image on a screen, and specifies the designated product by comparing the image on the screen with image data in the CM product database server. The system comprises a server that distributes CM product information by the CM providing company and includes sales information. If a product is specified, the viewer accesses a CM product information file storage region in the server according to the product information.

### SUMMARY OF THE INVENTION

However, in the clickable video map described above, defined click region information is also sent along with a moving image content. After distribution of moving image, link information cannot be changed or a click region cannot be changed, for example. Therefore, highly-maintainable information transmission is not possible like information distribution according to viewer interest.

According to Japanese Patent Application Laid-Open No. 2004-274350, the image distribution server and the information distribution server are provided independently, a Web page content of the information distribution server can be replaced as desired. However, an SMIL file is distributed during image distribution, so that a region associated with link information cannot be changed after the image distribution.

Further, since a data stream must contain complex designation, it is difficult to control detailed information link according to transition of a moving image scene.

The present invention provides a mechanism for creating information indicating a tendency of user interest based on user designation when an unspecified number of users designate particular places/parts in a desired content which especially interests them while viewing or listening to the content.

An interest information creation method according to an aspect of the present invention includes the steps of: requesting one or more respective terminal apparatuses to designate a content being individually provided to the respective terminal apparatuses and a desired element in the content; receiving designation information identifying the content and the desired element in the content designated by the respective terminal apparatuses from the respective terminal apparatuses; saving the designation information received from the respective terminal apparatuses; extracting designation information on a particular content from the designation information being saved; creating interest information indicating a tendency of content-user's interest in the particular content or a particular element in the particular content based on the designation information on the particular content being extracted; and associating the interest information with the designation information on the particular content and registering the associated information in a pre-determined interest information database.

Preferably, the content includes at least one of a still image content, a moving image content and an audio content, and each element in the content includes at least one of an arbitrary region in the still image content, an arbitrary region in an arbitrary frame in the moving image content and an arbitrary playback position or playback time in the moving image content or the audio content.

Preferably, the content includes at least one of content identification information uniquely identifying the content, playback position identification information identifying a playback position or playback time of each frame in the moving image content or each audio sound in the audio content, frame identification information identifying each frame in the moving image content and coordinates identification information identifying coordinates of each region in each frame in the moving image content.

Preferably, the designation information includes at least one of content identification information contained in the content, designated playback position identification information identifying a playback position or playback time of an element being arbitrarily designated in the moving image content or the audio content, designated frame identification information identifying a frame being arbitrarily designated in the moving image content, designated coordinates identification information identifying a coordinate point of a particular region in a frame being arbitrarily designated in the moving image content, identification information of a user of the terminal apparatus and date and time information of creation of the designation information.

Preferably, the method further includes the steps of: obtaining a subtotal of the number of pieces of designation information in each pre-determined counting unit which indicates a range from a playback start position to a playback end position of the particular content; and calculating a local average by averaging the subtotal of the number of pieces of designation information in each pre-determined counting unit by a total number of playback units of the particular content in the counting unit.

Preferably, the method further includes the step of creating diagrammatized information of the local average in the each pre-determined counting unit along a playback time axis of the particular content.

Preferably, the method further includes the step of calculating a total number of the designation information by calculating a total sum of the subtotal of the number of pieces of designation information in each pre-determined counting unit over the whole particular content.

Preferably, the method includes the step of calculating a designation information average obtained by averaging the total number of the designation information by a total number of playback units from the playback start position to the playback end position of the particular content.

Preferably, the method further includes the step of extracting a playback unit in a counting unit in which the local average becomes the local maximum.

Preferably, the method further includes the steps of: extracting frames in interest being one or more frames in the counting unit in which the local average becomes the local maximum among frames in the moving image content if the particular content is a moving image content and the playback unit is a frame of the moving image content; and specifying a region of interest for which coordinate points indicated by designated coordinates identification information corresponding to the frames in interest is a thick region.

Preferably, the method further includes the step of superposing a video picture indicating the region of interest on the frames in interest in the moving image content.

Preferably, the method further includes the steps of: setting a desired frame among the frames in interest as an origin frame; setting a desired region in the origin frame as a reference region; and tracing a correlated region being a region having a feature amount correlated to a feature amount of the set reference region with frames before or after the origin frame.

Preferably, the method further includes the steps of: setting a desired frame among the frames in interest as an origin frame; setting the specified region of interest as a reference region in the origin frame being set; and tracing a correlated region being a region having a feature amount correlated to a feature amount of the reference region being set with frames before or after the origin frame.

Preferably, the method further includes the step of, if an untraceable frame appears that is a frame by which the correlated region cannot be traced any more, setting the specified region of interest as a new reference region in the untraceable frame, and continuing tracing a correlated region of the new reference region being set by frames before or after the untraceable frame.

Preferably, the feature amount of the reference region in the origin frame includes at least one of hue of a region of interest in the origin frame, a shape, size or position of a material body in the reference region in the origin frame, a feature amount of texture in the reference region in the origin frame, and a difference between feature amounts of frames before or after the origin frame and a feature amount of the origin frame.

Preferably, the interest information includes the diagrammatized information.

Preferably, the interest information includes the total number of the designation information.

Preferably, the interest information includes the designation information average.

Preferably, the interest information includes at least one of playback position identification information of the frame in interest and coordinates identification information of the region of interest.

Preferably, the interest information includes coordinates identification information of the correlated region.

Preferably, the method further includes the step of, when a pre-determined time has been elapsed since saving of designation information collected from the respective terminal apparatuses, deleting the designation information being saved.

Preferably, the method further includes the steps of: designating an arbitrary content from which interest information is extracted; extracting interest information corresponding to the designated content from the interest information database; and providing the interest information extracted from the interest information database.

Preferably, the method further includes the steps of: registering desired related information corresponding to desired interest information among the extracted interest information in a pre-determined related information database; extracting interest information corresponding to designation information received from the respective terminal apparatuses from the interest information database; extracting related information corresponding to the interest information extracted from the interest information database from the related information database; and transferring the related information extracted from the related information database to each terminal apparatus.

An interest information creation apparatus according to an aspect of the present invention includes: a device which receives designation information identifying a content being individually provided to one or more respective terminal apparatuses and a desired element in the content from the respective terminal apparatuses; a device which saves the designation information received from the respective terminal apparatuses; a device which extracts designation information on a particular content from the designation information being saved; a device which creates interest information indicating a tendency of content-user's interest in the particular content or a particular element in the particular content based on the designation information on the particular content being extracted; and a device which associates the interest information with the designation information on the particular content and registering the associated information in a pre-determined interest information database.

An interest information creation system according to an aspect of the present invention includes: a device which requests one or more respective terminal apparatuses to designate a content individually provided to the respective terminal apparatuses and a desired element in the content; a device which receives designation information identifying the content and the desired element in the content designated by the respective terminal apparatuses from the respective terminal apparatuses; a device which saves the designation information received from the respective terminal apparatuses; a device which extracts designation information on a particular content from the designation information being saved; a device which creates interest information indicating a tendency of content-user's interest in the particular content or a particular element in the particular content based on the designation information on the particular content being extracted; and a device which associates the interest information with the designation information on the particular content and registering the associated information in a pre-determined interest information database.

According to the aspects of the present invention, interest information indicating an interest tendency of an unspecified number of content users is created from designation information being separate from content details themselves. The interest information is provided to an information distributor or an advertiser so that the information distributor or the advertiser can get user interest information. Then, the information distributor can provide appropriate information to each content user based on the interest information.

### BRIEF DESCRIPTION OF THE DRAWINGS

FIG. 1 is a diagram of the overall configuration of a related information transfer system;

FIGS. 2A, 2B and 2C are diagrams illustrating a moving image content and its related information;

FIG. 3 is a diagram showing an example of time to set related information;

FIG. 4 is a diagram illustrating related information;

FIG. 5 is a diagram showing an example of designation information saved in a query table;

FIG. 6 is a diagram illustrating the result of extraction of designation information corresponding to a particular content ID “A-001-87320” from the query table;

FIG. 7 is a diagram illustrating video pictures for which each subtotal of the number of pieces of designation information is graphed in each counting unit in the frame playback order;

FIGS. 8A and 8B are diagrams showing how designated addresses spread in a particular frame; and

FIGS. 9A and 9B are diagrams illustrating interest regions R1, . . . R10 in adjacent frames F1 to F10 traced with reference to a reference region R0 in a reference frame F0.

### DETAILED DESCRIPTION OF THE PREFERRED EMBODIMENTS

The following will describe the best mode to carry out the present invention with reference to the attached drawings.

### <Overview of Related Information Management System>

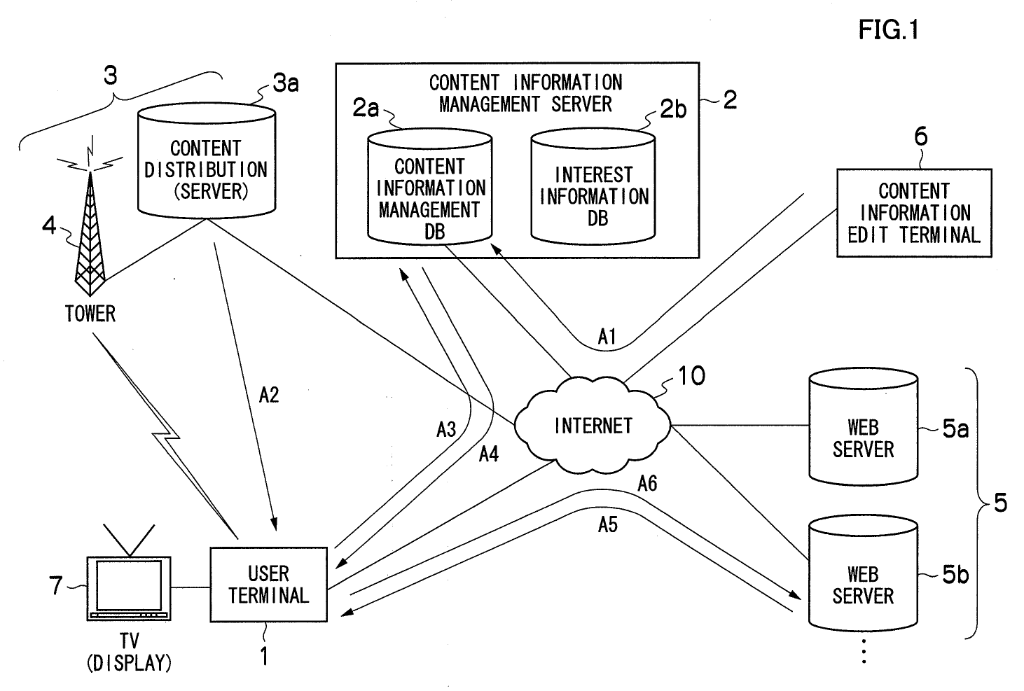

FIG. 1 shows the overall configuration of a related information management system according to a preferable embodiment of the present invention. The system comprises a user terminal 1 and a content information management server 2.

The user terminal 1 is provided with various contents including video pictures (still images or moving images) and audio directly as electric signals from a distribution side 3 such as a content distribution server 3a or a tower 4 of a TV station or by reading out a content recording signal from recording media such as DVD. The user terminal 1 is connected to an unspecified number of Web servers 5 (5a, 5b . . . ) via an Internet (network) 10.

The content information management server 2 is connected to a content information edit terminal 6 via the Internet 10.

The user terminal 1 can be a PC or an STB (set-top box) compatible with multimedia recording and playback. If a distributed content is a video picture, the terminal 1 can output the content to and display on a TV 7. If a distributed content is audio, the terminal 1 can output the content to a stereo for playback.

To use an existing TV and stereo, this embodiment is described assuming that the present invention is applied to an STB being separate from the TV and stereo. However, a similar function as embedded in the STB according to this embodiment can be embedded in the TV, stereo, or other AV equipment.

A scheme of content distribution from the distribution side 3 to the user terminal 1 is not limited particularly. For example, the scheme includes broadcast distribution such as by digital terrestrial broadcast or satellite broadcast, multicast distribution used in an Internet TV, unicast distribution such as VOD (video on demand) and streaming or the like. The scheme can also include dispersed distribution by cooperation with other peers on the Internet 10 instead of direct distribution from a content distribution server as in a peer-to-peer moving image distribution system. Content can also be provided in portable recording media such as DVD.

The content information management server 2 comprises a content information management DB 2a and an interest information DB 2b. The content information management DB 2a stores content-correspondent related information (hereinafter, simply referred to as related information) corresponding to details of a content to be distributed, which is created and uploaded in the content information edit terminal 6.

Related information is associated with information specifying a content title, a desired scene or the vicinity in a content.

Content distribution data contains information specifying a content title, and element identification information identifying particular elements of a content (a scene or the vicinity in a moving image, for example). For example, element identification information includes frame information, segment information, time information etc. in a content. Content distribution data can be encapsulated in or subbanded into element identification information.

The user terminal 1 accepts designation of a desired element in a distributed content through operation by a mouse or other pointing devices while playing back the content. This operation refers to operation to designate a particular position of a particular segment in a moving image/still image while the content is being played back on the TV 7, for example, or operation to designate a phrase pronounced at a particular time during audio playback.

In response to operation by a user to designate a particular element of a content, the user terminal 1 creates designation information identifying the content and element, and transmits the information to the content information management server 2.

Specifically, the user terminal 1 extracts an ID of a content being played back, element identification information corresponding to the user-designated element (frame information of a particular moving image, information of a position in a frame, and time information indicating a particular audio playback position) from the content distribution data, and handles the extracted information as designation information. Then, the terminal packetizes the extracted designation information to reconfigure the information as data to be transmitted to the content information management server 2, and transmits the data to the content information management server 2 via the Internet 10.

The content information management server 2 analyzes the designation information being sent from the user terminal 1. The server 2 searches the content information management DB 2a for related information corresponding to the content elements (a scene and place, for example) specified by position information or time information in the content specified by the ID contained in the designation information.

The related information corresponding to the designation information stored in the content information management DB 2a can be associated with any designation place in any designation scene in the content.

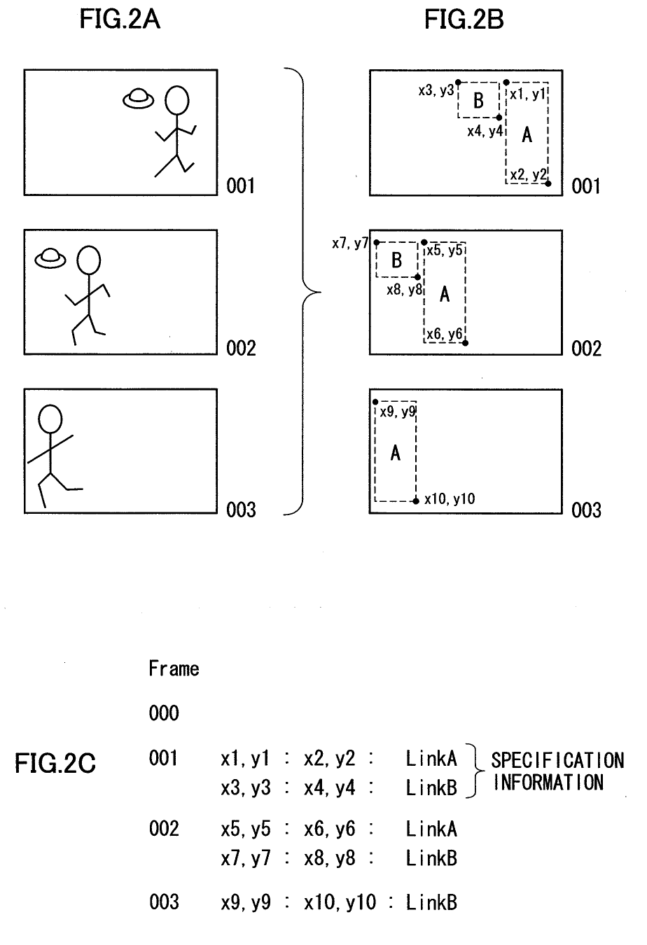

For example, in a segment “001” in a moving image such as a TV program as shown in FIG. 2A, a content element “region A” in right part as shown in FIG. 2B and a content element “region B” in an upper center may be designated according to user interest.

The content information management DB 2a can set any related information of each of the content elements at any time (preferably, after analysis of the designation information). For example, the DB 2a can define the content element “region A” in the segment “001” as a rectangular region with x1, y1 and x2, y2 and the content element “region B” as a rectangular region with x3, y3 and x4, y4, and set their corresponding related information.

Alternatively, in a segment “002” in the moving image, a content element “region A” in the center and a content element “region B” in left part may be arbitrarily designated. The DB 2a can define the content element “region A” in the segment “002” as a rectangular region with x5, y5 and x6, y6, the content element “region B” as a rectangular region with x7, y7 and x8, y8, and set their corresponding related information.

Alternatively, in a segment “003” in the moving image, a content element “region A” may be arbitrarily designated. The DB 2a can define the content element “region A” as a rectangular region with x9, y9 and x10, y10, and set its corresponding related information in the segment “003”.

In the above manner, content element regions moving independently can be defined in each segment, and their corresponding related information can be set. This enables association of a content element with related information as desired.

FIG. 2C shows one example of related information associated with the content elements “region A” and “region B” in each segment shown in FIG. 2B in the content information management DB 2a. For example, related information “Link A” is associated with the content element “region A”, while related information “Link B” is associated with the content element “region B”. It is arbitrary to associate which related information with which content element and details of the related information are arbitrary. That is, related information can be set much more freely and the maintainability of the related information is much higher than in a conventional clickable map in which related information is made to be dependent on a content element itself.

Additionally, the same related information can be associated with different elements in the same content. In this case, in distribution of a program by a sponsor A, for example, even if a user clicks in any scene and on any place, a URL of a Web site publishing advertisement information by the sponsor A can be sent back to the user terminal 1. Alternatively, multiple pieces of related information of advertisement information by a plurality of sponsors are registered in the same display area in the same scene, so that related information can be provided individually to viewers who have different interests depending on scenes.

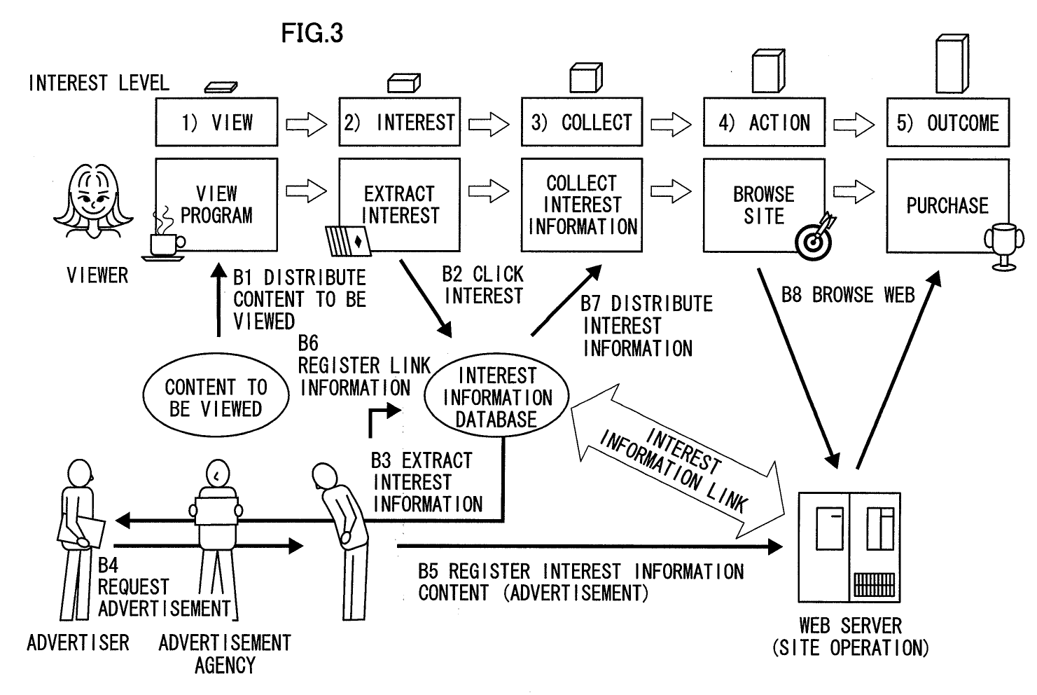

As described later in detail, according to the preferable embodiment of the present invention, after each user actually views a content, user interest is analyzed based on information designated by each user, and related information is set according to the result (FIG. 3). It is an object of the present invention to thoroughly analyze a tendency in the user interest, and register related information according to the user interest after the fact and effectively.

If the content information management DB 2a contains related information matching element identification information received from the user terminal 1, the content information management server 2 searches for the related information and sends back the information to the user terminal 1 which has sent designation information.

If the content information management DB 2a does not contain related information corresponding to the designation information received from the user terminal 1, this can be notified to administrators of the Web servers 5 to prompt the administrators to register related information.

According to the preferable embodiment of the present invention described later, since registration of related information is started after reception of designation information, the DB 2a does not always contain the related information corresponding to the designation information. Related information corresponding to certain designation information can also be sent back to the user terminal 1 as soon as the related information is recorded that corresponds to the designation information.

Related information contains, in addition to information necessary to access the servers 5 being access destinations (for example, URL: hereinafter, referred to as access destination information), buttons or other image data for GUI to indicate the access destinations, or deletion date data to indicate a date to delete the related information from the content information management server 2. According to deletion date data, a period can be set to provide information to the content information management server 2, and a period can be controlled to provide information to a user.

In parallel with content playback, the user terminal 1 receives, collects and organizes related information being occasionally sent from the content information management server 2, and displays the access destination information display buttons on the TV 7 based on the received related information according to operation to browse viewer-collected information.

When an access destination information display button is designated according to the user operation, the related information being received is displayed as a button menu on the TV 7. Then, a user selects a button of interest from the displayed access destination menu and pushes the button, the user terminal 1 accesses one of the Web servers 5 corresponding to the pushed button.

The Web server 5 sends back a Web content to the accessing user terminal 1. The user terminal 1 displays the Web content. This allows a user to browse a Web content associated with elements of interest in a distributed content (a scene, playback time, image segment, etc.).

If a content is a moving image, the distributed content is embedded with information that can uniquely specify the content, for example, ID information: zzz, and a frame number (1, 2, 3, . . . , fff) and time information (hh:mm:ss:xx), for example, of each frame in the moving image such that a playback side can gain the information during playback display. For example, when a viewer triggers to designate a particular scene while viewing the content, the playback side can gain the content ID information and information to specify the scene.

Video stream data is previously embedded with information to specify a content and information to specify a scene such that a playback side gains the information during playback. As such, the terminal 1 creates information to designate a scene of interest.

In a system adopting the MPEG2 scheme, which uses a time code parameter, a time code is embedded at distribution and the information is read at playback, so that a frame can be specified by utilizing the current video stream distribution specification. However, in DVD recording, the system has a drawback in that recorded data can be inconsistent with information managed by the content information management server 2 when the data is played back since a recorder might rewrite a time code parameter. Therefore, a time code parameter should be used to specify a frame for a program that cannot be recorded.

For ID information to specify a content, the terminal 1 obtains information of a chosen channel and viewing-time, and the content information management server 2 can call a content ID registered in an electronic program guide (EPG) from the information, for example.

The terminal 1 displays a pointer cursor on the screen of the TV 7 that is playing back a content, and obtains an address (a0, b0) indicating the position of a designated point on the screen on the pointer cursor. A viewer designates a part of interest in the content being viewed on the screen. The designated position has the address (a0, b0).

The extracted information is organized into information described in text data such as “click_info (ContentsID=zzzz, frameNo: ffff, address=a0, b0)”. The terminal 1 sends message information to the content information management server 2 according to SIP (Session Initiation Protocol) to transfer information to identify particular elements in a viewer-interested content to the content information management server 2.

The protocol does not need to be the SIP. However, if a large number of viewer terminals 1 and content information management servers 2 irregularly exchange information, all the terminals 1 and servers 2 do not need to be connected with one another in the SIP, which lightens the load.

The content information management server 2 specifies an address on the Internet 10 of the relevant user terminal 1 from an SIP packet sent from the user terminal 1, retrieves text message information contained in the SIP packet, and inquires the information (click_info) of the content information management DB 2a.

The content information management DB 2a extracts related information based on query details. Specifically, the DB 2a searches the database table recorded for each Contents ID shown in FIG. 2C, for example, for a frame number (for example, frameNo=002) described in click_info information sent from the user terminal 1, and determines whether or not regions associated with “002” (for example, two rectangular regions x1, y1|x2, y2 and x3, y3|x4, y4) are contained in an area of a click point (for example, a1, b1). If they are contained, the DB 2a extracts related information associated with the specification information (for example, Link A). To prevent useless queries, a query can be permitted only after registration of related information.

The above has described one example of transferring related information through message exchange according to the SIP protocol, but the transfer method is not limited to the example. For example, if the user terminal 1 sends designation information extracted by the user terminal 1 as well as a desired e-mail address to the content information management server 2, the server 2 can transmit related information retrieved from the content information management DB 2a in an e-mail format to the e-mail address. This allows for a terminal (for example, a mobile terminal such as a mobile phone) different from that which has sent designation information to use the related information.

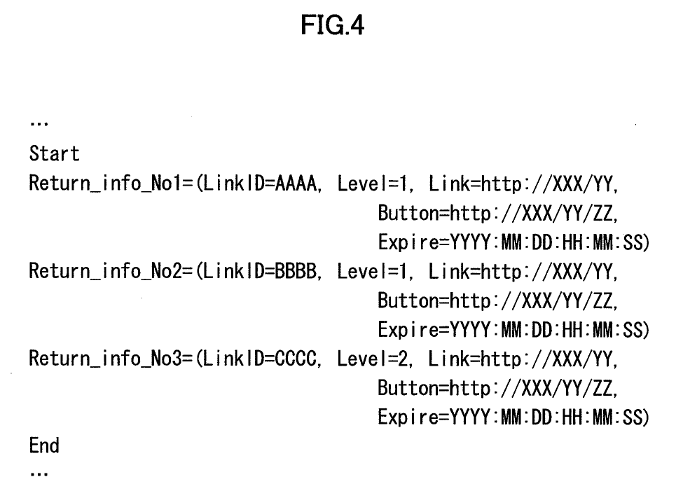

FIG. 4 shows a specific example of related information. In the drawing, the content information management DB 2a extracts three pieces of related information based on particular elements (positions) in a particular scene clicked by the user terminal 1.

The content information management DB 2a may contain multiple pieces of access destination information for query information. For example, those can be extracted includes: an information link to an object itself clicked in a certain scene; a link to an object at one clicked point such as an information link to a sponsor product part in a CM scene or an information link to the program sponsor in the case of a click in the CM scene of a certain program; and related information of a pre-determined area including a clicked scene (for example, the previous and next scenes of the clicked scene).

A Link ID is an ID to identify access destination information. The ID can be used to prevent the user terminal 1 from displaying the same information redundantly if the same ID is clicked for many times and the same information is returned.

A Level is to assume and set the correlation of attention by a viewer of its related information. When an object is clicked that is highly dependent on a scene, a Level assumes and sets the correlation of viewer attention to its related region. For example, if a whole program is clicked, then Level=3.

This controls display of the priority of information displayed on the user terminal 1 of a viewer.

A Button indicates an address of a server that stores image data of a banner button displayed on the user terminal 1 of a viewer (a button to indicate an access destination). Data being some load on the content information management server 2 like image data is kept with being dispersed on the Web servers 5 of a sponsor, for example. As such, the sponsor itself can change the data as desired and a load on the content information management server 2 is reduced.

When the access destination information is sent back to the user terminal 1, the terminal 1 automatically registers the information in the access destination information management table and downloads image data of a banner button from the Web servers 5 or the content information management server 2.

Expire indicates an effective period of the related information. For example, it is used to delete the related information before deleting a content from the Web servers 5 of a sponsor from the user terminal 1. Expire times in the drawing are all the same, but they can be set differently from one another.

A charging system can be built that defines an advertisement fee of a sponsor from the ranges (registration area*time) of related information registered in the content information management DB 2a or a period to keep the related information in the user terminal 1, or gets an incentive fee from the fact that a viewer actually clicked a button through the user terminal 1.

### First Embodiment

The following will describe a particular embodiment of creation of interest information corresponding to a moving image content. According to this embodiment, the creation of interest information is performed before registration of related information in the content information management DB 2a.

The content information management server 2 receives designation information at random times and without related details from each user terminal 1. The content information management server 2 sequentially saves the designation information received from each user terminal 1 in a query table of a content information management DB 2.

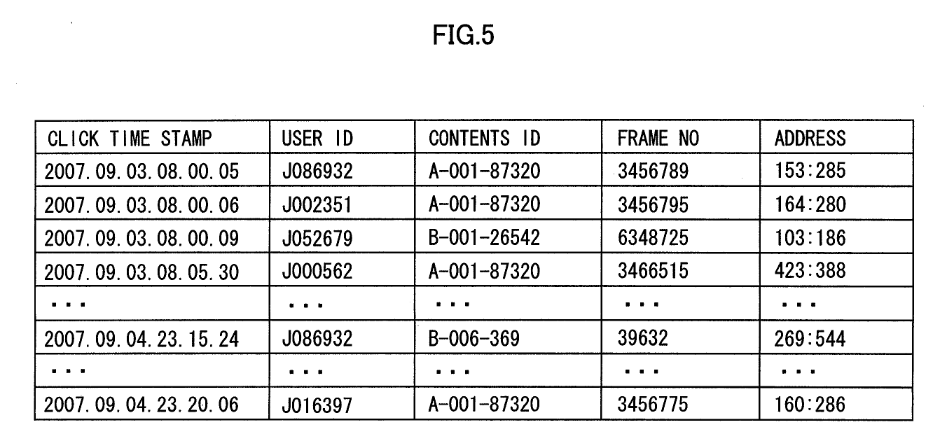

FIG. 5 shows one example of the designation information saved in the query table. The query table contains at least one of creation date and time of the designation information, transmission date and time or reception date and time (a click time stamp), user identification information (a user ID), content identification information (a content ID), and content element identification information (a frame number and an address of a region in a frame) as saved items.

For example, referring to designation information in a first column and a second column, while different users having user IDs “J086932” and “J002351” are viewing the same moving image content, a content “A-001-87320”, they are interested in close regions “153:285” and “164:280” in frames having close frame numbers “3456789” and “3456795” in the content and transmit designation information of the regions from their user terminals 1.

Referring to designation information in a third column, while a user having a user ID “J052679” is viewing a different content “B-001-26542” at approximately the same time as the first column and the second column, the user is interested in the content.

Referring to designation information in a fourth column, a user having a user ID “J000562” who is viewing the same content as the first column to the second column is interested in a region “423:388” in a frame having a frame number “3466515”, and transmits the designation information of the region.

Referring to designation information in a sixth column, a creation date of the designation information differs from that of the first to fourth columns, the user having the same user ID “J086932” as the first column views a different content “B-006-369” from the first column and is interested in the content.

Referring to designation information in an eighth column, a user having a user ID “J016397” views the same content as the first to second columns at different time from the first to second columns for recording and playback, for example, and is interested in the content.

The items to be saved in the table as shown are only examples. For example, time information can be provided instead of a frame number to specify a playback position or playback time of a content element.

The designation information saved in the query table is deleted when a pre-determined time (for example, a week) has elapsed from the start of the saving. This is to prevent continuing meaningless saving because impression of the content on a user will weaken over time so that the information saved in the query table will be useless as information to analyze user interest.

The content information management server 2 accepts input of identification information (a content ID) of a content for analysis of viewer interest via an input device such as a mouse or keyboard.

The content information management server 2 extracts only designation information with the inputted content ID from the query table.

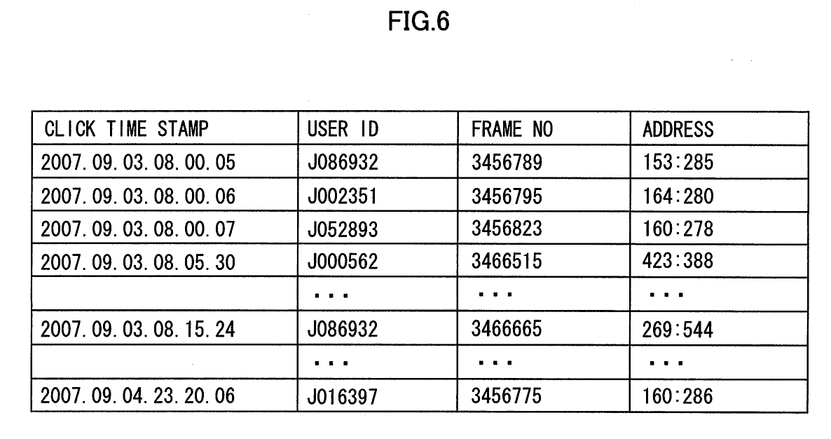

FIG. 6 illustrates a result of extracting designation information corresponding to a particular content ID “A-001-87320” from the query table. Of course, if another content ID is inputted, designation information corresponding to the content ID is extracted.

Referring to first to third columns, different users are viewing the same content, are interested in approximately the same positions in scenes in the vicinity of one another at approximately the same time, and designate the positions.

Referring to a fourth column, another user is interested in a different scene from the first column and designates the scene.

Referring to a sixth column, the same user as the first column is interested in a different scene from the first column and designates the scene.

Referring to an eighth column, still another user records a content in a recorder, plays back the content on another date, is interested in a position in the vicinity of the scenes which the users in the first to third columns are interested in and designates the position.

From the extraction result, interest information is created that indicates a tendency of user interest in the designated contents.

First, frames constituting certain areas of a designated content (for example, 500 frames from the first frame to the last frame of the content) are partitioned by a pre-determined number (for example, 11 frames), and content fragments got as a result of the partitioning are set as a counting unit. Then, an average of the number of pieces of designation information corresponding to the minimum playback unit being a counting unit, i.e., each frame in each counting unit is calculated. That is, a simple moving average of the number of pieces of designation information corresponding to frames in a certain area of the designated content is taken.

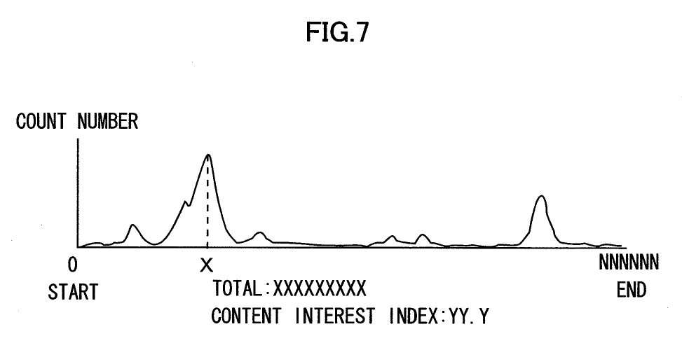

FIG. 7 illustrates a video picture in which the subtotal number of pieces of designation information in each counting unit is graphed along a frame playback time axis i.e., in the playback order. In the two-dimensional coordinates on which the subtotal data is plotted, the abscissa axis is a frame playback time axis, while the ordinate axis is subtotals of designation information. The graphed video picture is created arbitrarily. Referring to the graphed video picture, it can be seen which counting unit indicates concentrated reception of designation information because many users interested in the information.

Alternatively, the total of the number of pieces of designation information (the total number of clicks) corresponding to frames in a certain area of a designated content can be calculated, or a value obtained by dividing the total click number by the total number of frames in the certain area (a content interest index) can be calculated. The total click number indicates the number of times that a designated content interests users, and a content interest index indicates the number of times that a frame interests users. With the indices, it can be roughly evaluated how users are interested in the whole content.

Next, frames in a counting unit in which the simple moving average becomes the local maximum (for example, in the vicinity of a counting unit X in FIG. 7) are extracted from the designated content as interesting frames.

Then, a region (interesting region) is analyzed on which addresses (designated addresses) concentrate that are contained in designation information corresponding to the respective extracted interesting frames.

An interesting region is specified in an arbitrary manner. For example, the content information management server 2 divides an entire frame into a plurality of small regions (for example, 100×100 small regions being equally divided), and counts the total number of designated addresses in each small region. If the number of designated addresses in the small region exceeds a pre-determined threshold (for example, 100), it is determined that the small region contains “thick” designated addresses. The determination is performed for all the small regions, neighboring ones of “thick” small regions are integrated, and it is eventually determined that the integrated region is an interesting region. As a result, a plurality of regions containing concentrating addresses may be separate from one another (for example, at the left end and the right end of a screen). This is because not only one part interesting users is in a frame, but such parts can be dispersed over a frame.

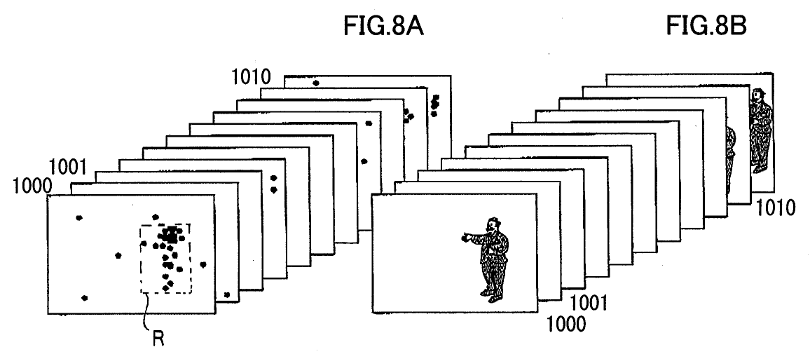

From FIG. 8A, it can be seen that there is a region R containing concentrating addresses of designation information corresponding to a frame with a frame number “1000”, for example. It should be noted that the region R is only to indicate the concentration of designation information, but is separate information from details of the content. Such region can be significant by being associated with the content details themselves.

That is, to know user interest, specification of an interesting region is not sufficient, but an interest analyst needs to find out which part of which content the region corresponds to.

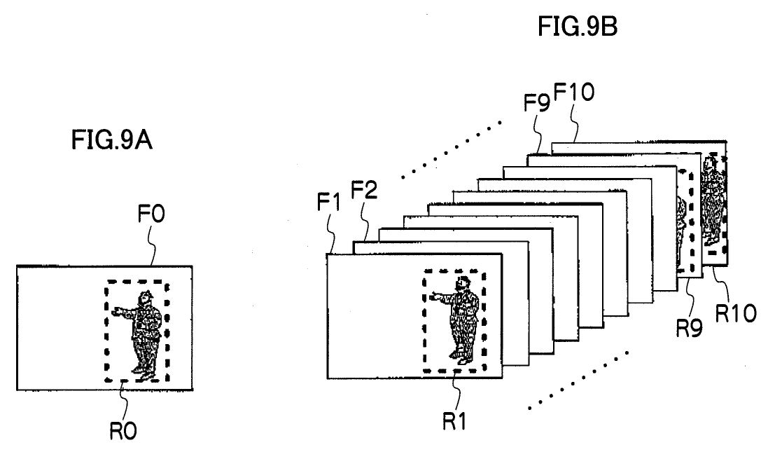

In view of the above, the content information management server 2 should create information indicating the position of an interesting region in an interesting frame of a designated content, for example, a video picture in which an outer edge R of an interesting region as shown in FIG. 9A are superposed on an interesting frame F0, and display the video picture on a display apparatus such as a display.

Analysis of transition of user interest in consecutive frames along the playback time axis will be described below.

First, as shown in FIG. 9A, the content information management server 2 sets any region in any interesting frame (a user-designated initial frame F0) to which an interest analyst infers that a user pays attention and which is arbitrarily designated based on operation of an input device by the analyst, or a specified interesting region in an arbitrarily designated interesting frame (an automatically designated initial frame F0) as an initial reference region (R0). Preferably, the automatically designated initial reference region R0 is the interesting region R.

Next, the server 2 extracts the feature amount of the initial reference region. The feature amount can be a static numerical value got from image data itself in the initial reference region or a dynamic numerical value considering external factors in addition to the image data in the initial reference region. A static numerical value is the hue of the reference region, the shape of a material body in the reference region or the figure pattern (texture) of the material body, for example. If the material body is a face of a person, the feature amount can be a feature amount of the face of the person (a skin color, eye color, facial contour, relative positions of facial parts such as eyes, a nose and a mouth). An example of a dynamic numerical value will be described later.

A reference region is traced from an initial reference region as the origin along a content playback time axis, and transits frame by frame before or after the initial frame. A tracing direction (forward or backward along the playback time axis) can be arbitrarily designated through input operation by an analyst.

That is, first, the feature amount is extracted from the initial reference region R0 in the initial frame. Next, in a frame adjacent to the initial frame in a designated tracing direction (the next frame, for example, F1 to be played back next to F0), a region correlating to the feature amount of the initial reference region (correlated region) is specified. For example, a region matching the hue of the initial reference region, a shape and figure of a material body by pre-determined certainty or more (for example, 70% or more) is specified as a correlated region.

Next, the specified correlated region is set as a new reference region, and a region correlating the feature amount of the reference region is specified from a next frame (for example, F2).

The above procedure are repeated including setting of a reference region, specification of a correlated region, and resetting of the correlated region as a reference region. In the procedure, the feature amount of a reference region in the next frame can be a difference between the feature amount of a reference region in a reference frame and the feature amount of a correlated region in the next frame. If an accumulation of differences is larger each time a reference region is reset, it means that a current reference region is deviating from the initial reference region. If the accumulation of differences is a certain pre-determined acceptable value or more, and a current reference region is not same as the initial reference region, then it can be determined that there is no correlation between the initial reference region and the reference region.

When a person or other objects in an initial reference region are out of frame or an object changes significantly (for example, from the whole body to the closed-up face), the correlated region cannot be specified, so that the tracing of a correlated region is ended.

In a frame in which the correlated region tracing ends, a new initial reference region is set similarly to the above, and the correlated region tracing is continued based on the reference region. An initial reference region can be set arbitrarily.

A frame number of a frame in interest (playback position identification information) in which a correlated region can be traced based on a certain initial reference region, position coordinates of an interesting region (coordinates identification information), and position coordinates of the correlated region (coordinates identification information) are associated with designation information as interest information and stored in the interest information DB 2b.

The interest information can include position coordinates of the initial reference region, the total click number, a content interest index, a graph of subtotals of the number of pieces of designation information etc. in addition to the above information.

An analyst of user interest (a distributor of related information) can know which object in which scene of a moving image a user is especially interested in by collating the actual moving image content with the interest information.

The interest information is provided to the analyst by being displayed on the content information management server 2 or a display apparatus connected to other computers, recorded on a portable recording medium, or printed on a print medium via a printer. The analyst registers related information corresponding to designation information sent from each user according to the interest information.

The registration is realized as follows. For example, similarly to the terminal 1, an input operation apparatus of the content management server 2 is used to designate a desired coordinate point or the position of a region (related information set target position) in each of one or more desired frames (related information set target frames) of a desired content (related information set target content). The desired coordinate point or position of a region to be designated can be arbitrarily selected from an unspecified number of designated addresses, which makes the selection inefficient if the number is enormous. As such, arbitrary selection from interesting regions on which users' favor concentrates is preferable.

The interest information DB 2b extracts designation information corresponding to interest information with the related information set target position being designated. The content information management DB 2a accepts input of desired related information, associates the designation information extracted from the interest information DB 2b with the desired related information being inputted, and registers the result. In this manner, designation information is associated with related information via particular interest information.

For an analyst, it is convenient to collectively register related information for designation information from an unspecified number of users being interested in a particular object (for example, a particular actor acting in a drama) by using the object as a key.

For example, if interest information concentrates on a particular actor acting in a drama, a distributor may want to register a web site address of an agency of the actor, a blog address of the actor, a web site address introducing TV programs and CMs in which the actor acting, for example, as related information.

The registration is realized as follows. For example, similarly to the terminal 1, an input operation apparatus of the content management server 2 is used to designate a desired coordinate point or the position of a region (related information set target position) in each of one or more desired frames (related information set target frames) of a desired content (related information set target content).

If a direct related information set target frame and a related information set target position are designated, the content management server 2 extracts a region matching a target region of each target frame designated through an input operation apparatus (which may not be completely same, but may be a region overlapping by a pre-determined percentage. For example, designation information corresponding to interest information with a region overlapping by 90% or more can be regarded as matching) as an interesting region from the interest information DB 2b.

That is, if a desired region of a desired frame with which an analyst wants to associate related information is recorded as interest information, all designation information corresponding to the interest information, i.e., information indicating interest of an unspecified number of users in a target region of the target frame is extracted.

To automatically designate a target region only of a particular object, a target region of a certain frame is set, correlated regions following the region as a reference region are sequentially linked, and all the linked correlated regions are collectively designated as target regions. In this manner, the same object in a series of frames can be collectively designated as target regions.

It can depend on attributes of an object in a target region that designation information by how many users is extracted for a certain analysis region. Assume that people appear in a scene containing a moving image, one of them is a famous actor while the other people are unknown actors. If the famous actor is designated as an analysis region, multiple pieces of designation information are extracted. If the unknown actors are designated as analysis regions, not so many pieces of designation information are extracted.

Then, it should be determined what related information is associated with a target position by considering the nature of an object in the target region, and the number of pieces of designation information being extracted.

In the above manner, interest information can be created from designation information of a particular object in a moving image content, arbitrary related information can be associated with the designation information with reference to the interest information, and related information can be distributed according to user interest. This enables information distribution particularly according to user interest in details of a provided content.

### Second Embodiment

A content is not limited to a moving image, but can be one or more still images, character information, audio or the like. If a content is a plurality of still images or character information, interest information is similar to the first embodiment.

If a content is audio, interest information contains an audio utterance position or utterance time instead of a frame number and coordinates information. When many listeners respond to particular audio details, a time when the audio details are streamed is designation information.

What is claimed is:

1. An interest information creation method comprising the steps of:
requesting one or more respective terminal apparatuses to designate a content being individually provided to the respective terminal apparatuses and a desired element in the content;
receiving designation information identifying the content and the desired element in the content designated by the respective terminal apparatuses from the respective terminal apparatuses;
saving the designation information received from the respective terminal apparatuses;
extracting designation information on a particular content from the designation information being saved;
creating interest information indicating a tendency of content-user's interest in the particular content or a particular element in the particular content based on the designation information on the particular content being extracted; and
associating the interest information with the designation information on the particular content and registering the associated information in a pre-determined interest information database.

2. The interest information creation method according to claim 1, wherein
the content includes at least one of a still image content, a moving image content and an audio content, and each element in the content includes at least one of an arbitrary region in the still image content, an arbitrary region in an arbitrary frame in the moving image content and an arbitrary playback position or playback time in the moving image content or the audio content.

3. The interest information creation method according to claim 2, wherein
the content includes at least one of content identification information uniquely identifying the content, playback position identification information identifying a playback position or playback time of each frame in the moving image content or each audio sound in the audio content, frame identification information identifying each frame in the moving image content and coordinates identification information identifying coordinates of each region in each frame in the moving image content.

4. The interest information creation method according to claim 3, wherein
the designation information includes at least one of content identification information contained in the content, designated playback position identification information identifying a playback position or playback time of an element being arbitrarily designated in the moving image content or the audio content, designated frame identification information identifying a frame being arbitrarily designated in the moving image content, designated coordinates identification information identifying a coordinate point of a particular region in a frame being arbitrarily designated in the moving image content, identification information of a user of the terminal apparatus and date and time information of creation of the designation information.

5. The interest information creation method according to claim 4, further comprising the steps of:
obtaining a subtotal of the number of pieces of designation information in each pre-determined counting unit which indicates a range from a playback start position to a playback end position of the particular content; and
calculating a local average by averaging the subtotal of the number of pieces of designation information in each predetermined counting unit by a total number of playback units of the particular content in the counting unit.

6. The interest information creation method according to claim 5, further comprising the step of
creating diagrammatized information of the local average in the each pre-determined counting unit along a playback time axis of the particular content.

7. The interest information creation method according to claim 5, further comprising the step of
calculating a total number of the designation information by calculating a total sum of the subtotal of the number of pieces of designation information in each pre-determined counting unit over the whole particular content.

8. The interest information creation method according to claim 5, further comprising the step of
calculating a designation information average obtained by averaging the total number of the designation information by a total number of playback units from the playback start position to the playback end position of the particular content.

9. The interest information creation method according to claim 5, further comprising the step of
extracting a playback unit in a counting unit in which the local average becomes the local maximum.

10. The interest information creation method according to claim 9, further comprising the steps of:
extracting frames in interest being one or more frames in the counting unit in which the local average becomes the local maximum among frames in the moving image content if the particular content is a moving image content and the playback unit is a frame of the moving image content; and
specifying a region of interest for which coordinate points indicated by designated coordinates identification information corresponding to the frames in interest is a thick region.

11. The interest information creation method according to claim 10, further comprising the step of
superposing a video picture indicating the region of interest on the frames in interest in the moving image content.

12. The interest information creation method according to claim 10, further comprising the steps of:
setting a desired frame among the frames in interest as an origin frame;
setting a desired region in the origin frame as a reference region; and
tracing a correlated region being a region having a feature amount correlated to a feature amount of the set reference region with frames before or after the origin frame.

13. The interest information creation method according to claim 10, further comprising the steps of:
setting a desired frame among the frames in interest as an origin frame;
setting the specified region of interest as a reference region in the origin frame being set; and
tracing a correlated region being a region having a feature amount correlated to a feature amount of the reference region being set with frames before or after the origin frame.

14. The interest information creation method according to claim 13, further comprising the step of
if an untraceable frame appears that is a frame by which the correlated region cannot be traced any more, setting the specified region of interest as a new reference region in the untraceable frame, and continuing tracing a correlated region of the new reference region being set by frames before or after the untraceable frame.

15. The interest information creation method according to claim 12, wherein
the feature amount of the reference region in the origin frame includes at least one of hue of a region of interest in the origin frame, a shape, size or position of a material body in the reference region in the origin frame, a feature amount of texture in the reference region in the origin frame, and a difference between feature amounts of frames before or after the origin frame and a feature amount of the origin frame.

16. The interest information creation method according to claim 6, wherein
the interest information includes the diagrammatized information.

17. The interest information creation method according to claim 7, wherein
the interest information includes the total number of the designation information.

18. The interest information creation method according to claim 8, wherein
the interest information includes the designation information average.

19. The interest information creation method according to claim 10, wherein
the interest information includes at least one of playback position identification information of the frame in interest and coordinates identification information of the region of interest.

20. The interest information creation method according to claim 12, wherein
the interest information includes coordinates identification information of the correlated region.

21. The interest information creation method according to claim 1, further comprising the step of
when a pre-determined time has been elapsed since saving of designation information collected from the respective terminal apparatuses, deleting the designation information being saved.

22. The interest information creation method according to claim 1, further comprising the steps of:
designating an arbitrary content from which interest information is extracted;
extracting interest information corresponding to the designated content from the interest information database; and
providing the interest information extracted from the interest information database.

23. The interest information creation method according to claim 22, further comprising the steps of:
registering desired related information corresponding to desired interest information among the extracted interest information in a predetermined related information database;
extracting interest information corresponding to designation information received from the respective terminal apparatuses from the interest information database;
extracting related information corresponding to the interest information extracted from the interest information database from the related information database; and
transferring the related information extracted from the related information database to each terminal apparatus.

24. An interest information creation apparatus comprising:
a device which receives designation information identifying a content being individually provided to one or more respective terminal apparatuses and a desired element in the content from the respective terminal apparatuses;
a device which saves the designation information received from the respective terminal apparatuses;
a device which extracts designation information on a particular content from the designation information being saved;
a device which creates interest information indicating a tendency of content-user's interest in the particular content or a particular element in the particular content based on the designation information on the particular content being extracted; and
a device which associates the interest information with the designation information on the particular content and registering the associated information in a pre-determined interest information database.

25. An interest information creation system comprising:
a device which requests one or more respective terminal apparatuses to designate a content individually provided to the respective terminal apparatuses and a desired element in the content;
a device which receives designation information identifying the content and the desired element in the content designated by the respective terminal apparatuses from the respective terminal apparatuses;
a device which saves the designation information received from the respective terminal apparatuses;
a device which extracts designation information on a particular content from the designation information being saved;
a device which creates interest information indicating a tendency of content-user's interest in the particular content or a particular element in the particular content based on the designation information on the particular content being extracted; and
a device which associates the interest information with the designation information on the particular content and registering the associated information in a pre-determined interest information database.
